(19) United States
(12) Patent Application Publication
(10) Pub. No.: US 2014/0150699 A1
(43) Pub. Date: Jun. 5, 2014

(54) METHOD AND FOSSIL-FUEL-FIRED POWER PLANT FOR RECOVERING A CONDENSATE

(71) Applicants: Rudiger Schneider, Eppstein (DE); Henning Schramm, Frankfurt am Main (DE)

(72) Inventors: Rudiger Schneider, Eppstein (DE); Henning Schramm, Frankfurt am Main (DE)

(73) Assignee: SIEMENS AKTIENGESELLSCHAFT, Munich (DE)

(21) Appl. No.: 14/234,898

(22) PCT Filed: Jul. 24, 2012
(86) PCT No.: PCT/EP2012/064522

§ 371 Date: Jan. 24, 2014

(30) Foreign Application Priority Data
Jul. 29, 2011 (EP) 11175948.6

(51) Int. Cl. B01D 53/14; B01D 53/00; F23J 15/02

(52) U.S. Cl. CPC B01D 53/1475; F23J 15/02; B01D 53/002
USPC 110/345; 110/203; 62/617

(57) ABSTRACT

A fossil-fuel-fired power plant, having a combustion device, a CO₂ separation device, which is arranged downstream of the fossil-fuel-fired power plant, for removing CO₂, and a CO₂ compressor station, which is arranged downstream of the CO₂ separation device and which has a number of compressor stages and coolers for intermediate cooling is provided. The coolers are connected to the CO₂ separation device or the fossil-fuel-fired power plant by means of a condensate line in order to recover condensate. A method for carrying out the condensate recovery is also provided.

### CROSS REFERENCE TO RELATED APPLICATIONS

This application is the U.S. National Stage of International Application No. PCT/EP2012/064522 filed Jul. 24, 2012, and claims the benefit thereof. The International Application claims the benefit of European Application No. EP11175948 filed Jul. 29, 2011. All of the applications are incorporated by reference herein in their entirety.

### FIELD OF INVENTION

The present invention relates to a fossil-fuel fired power plant for recovering a condensate and methods therefor.

### BACKGROUND OF INVENTION

In fossil-fired power plants for generating electric energy, a flue gas containing carbon dioxide is produced as a result of the combustion of a fossil fuel. For avoiding or for reducing carbon dioxide emissions, carbon dioxide must be separated from the flue gases. For separating carbon dioxide from a gas mixture, different methods are universally known. In particular, for separating carbon dioxide from a flue gas after a combustion process, the method of absorption-desorption is common. On a commercial scale, carbon dioxide is washed out of the flue gas with a solvent (CO₂ capture process) in this case.

Common absorption mediums are aqueous solutions of a wash-active additive, such as monoethanolamine (MEA), amino-acid salts or potash. These wash-active additives feature a good selectivity and a high capacity for carbon dioxide (CO₂).

During operation of the CO₂ capture process, however, some of the water invariably continuously evaporates. The water vapor is discharged from the absorber together with the flue gas which is cleaned of CO₂. As a result of the discharging of water from the absorption medium circuit, the dilution ratio between water and the wash-active additives, such as amines, amino-acid salts or potash, is altered. Therefore, makeup water must be fed continuously to the absorption medium circuit in order to compensate for the water which is discharged as a result of evaporation.

A power plant and method in which the condensate occurring in the compression of flue gas is returned back to the water-steam cycle of the power plant is already known from WO 2011006882 A2. A CO₂ separation apparatus, in which the separated CO₂ is compressed, and the condensate thereby occurring is discharged, is known from U.S. Pat. No. 5,025,631 A. WO 2011003892 A2 discloses a method and a power plant comprising CO₂ separation with heat recovery, in which the condensate from the CO₂ separation apparatus is separated and discharged.

For the feed of makeup water, a demineralized water (demin-water) is frequently used. For provision of this water, high costs are partly incurred.

In power plants which are retrofitted with CO₂ separation apparatus a demin-water treatment plant must also be provided at the same time, bringing with it high investment and operating costs. Such demin-water treatment plants are even already installed in a required volume in power plants which are prepared as a capture-ready plant just for a later retrofit or installation of a CO₂ separation process. In power plants which are still not prepared as being capture-ready, it is necessary to extend the existing demin-water treatment plant of the power plant during the process of retrofitting CO₂ separation apparatus.

### SUMMARY OF INVENTION

It is therefore an object herein to provide a fossil-fired power plant by which the costs for the installation and the operation of a demin-water treatment plant can be reduced despite installation of CO₂ separation apparatus which is connected to the power plant. It is also an object herein to provide a method for recovery of condensate, as a result of which the demin-water treatment plant of a power plant with associated CO₂ separation apparatus can be relieved of load.

These objects are achieved by means of a fossil-fired power plant according to embodiments described herein. The fossil-fired power plant accordingly comprises fossil-fired combustion apparatus in which as a result of the combustion of fossil fuels a flue gas containing CO₂ is formed. Connected downstream to the power plant is CO₂ separation apparatus for separating CO₂ from the flue gas. This comprises an absorber and a desorber which are connected into an absorption medium circuit. For liquefying the CO₂ which is separated in the CO₂ separation apparatus, a CO₂ compressor station, which is connected to the desorber for the discharge of separated CO₂, is connected downstream to the CO₂ separation apparatus. The compressor station in this case comprises a compressor with a number of compressor stages, wherein a cooler for cooling the compressed CO₂ is connected between the compressor stages in each case. The condensate, which is formed during the cooling of the compressed CO₂, is now fed back via a condensate line to the CO₂ separation apparatus and/or to the fossil-fired power plant.

An aspect in this case utilizes the fact that the condensate, which accumulates during compression of the CO₂, has high quality. Further use of the condensate is also particularly advantageous because of this since during the compression of the CO₂ large volumes of condensate accumulate. Filters or additional separators can additionally be connected into the condensate line in this case in order to filter out residues which are present in the condensate.

As a result of the connection according to the invention of the cooler of the CO₂ compressor via a condensate line to the CO² separation apparatus or to the fossil-fired power plant, in the case of a new construction of the power plant the demin-water treatment plant can be of a correspondingly smaller construction since it has to provide only a significantly reduced volume of demin-water for the CO₂ separation apparatus.

In a particularly favorable development, the condensate line is connected to a demin-water treatment plant of the fossil-fired power plant for providing demineralized water so that water which condenses during the intercooling of the CO₂ can be made available to the treatment plant as prepurified water. In the treatment plant, the condensate in this case is additionally freed of residual impurities, especially such as residues of active additives or CO₂.

In a further preferred embodiment, the condensate line is connected directly to the absorption medium circuit of the CO₂ separation apparatus so that water which condenses during the intercooling of the CO₂ can be provided directly as makeup water flow for the CO₂ separation apparatus. It is particularly advantageous in this case if a reservoir for condensate is connected into the condensate line so that the condensate can be temporarily stored. Furthermore, a control device can also be connected into the condensate line so that the condensate can be fed to the CO₂ separation apparatus in a specifically controlled manner.

Alternatively, or in combination with the connection of the condensate line to the CO₂ separation apparatus, the condensate line can be connected to a water-steam cycle of the fossil-fired power plant so that water which condenses during the intercooling of the CO₂ can be provided as feed water for the power plant. Also possible in this case is a temporary storage reservoir, or a control process, which correspondingly introduces condensate into the water-steam cycle depending upon the feed water which is to be fed. The introduction of condensate into the condenser of the water-steam cycle is advantageous in this case since as a result of the condensate the condensing in the condenser is benefited. Also worthwhile is a control system which, depending upon the requirement for water which is to be fed, directs or distributes the condensate either as makeup water to the CO₂ separation process or as feed water to the water-steam cycle.

The condensate can also be advantageously provided as process water for the power plant. In the conventional power plant for power generation, there is a requirement for demin-water at different points for additional processes. To this end, it is provided that the condensate line is connected to a process water line of the fossil-fired power plant so that the water which condenses during the intercooling of the CO₂ can be fed as condensate to various processes.

The object of the invention which is directed towards a method is achieved by means of the features described herein. For recovery of condensate and for relieving the load of a water treatment plant, which is a component part of a fossil-fired power plant process, condensate from the intercooling of a compression of CO₂ is fed back again to the CO₂ separation process, which is connected downstream to the power plant, or to the power plant process.

The condensate is expediently fed in this case as prepurified water to a treatment process for demineralized water (demin-water treatment plant) which covers the power plant process. As a result, the water treatment process is significantly relieved of load since less mineralized fresh water has to be introduced into the process from outside.

It is also particularly advantageous if the condensate is fed as makeup water to the CO₂ separation process of a water circuit which includes an absorption and desorption process. Alternatively or in addition to this, it is also advantageous if the condensate is fed as feed water to a water-steam cycle of the power plant process. Also alternatively or in addition to feed back as makeup water or feed water, the condensate can also be fed as process water to a process which is connected to the power plant process.

The method is particularly advantageously suitable in combination with an amino-acid salt as wash-active substance since the amino-acid salt has no appreciable vapor pressure in comparison to amines and therefore cannot be discharged either from the CO₂ separation process by way of the condensate. The condensate therefore has a particularly high degree of purity when using amino-acid salts since it is free of wash-active substances or residues thereof.

### BRIEF DESCRIPTION OF THE DRAWINGS

Exemplary embodiments of the invention are explained in more detail in the following text with reference to figures. In the drawing:

FIG. 1 shows a fossil-fired power plant with a condensate feedback line into the absorption medium circuit and into the water-steam cycle of the power plant,

FIG. 2 shows a method for relieving the load of a water treatment plant of a fossil-fired power plant with CO₂ separation apparatus.

### DETAILED DESCRIPTION OF INVENTION

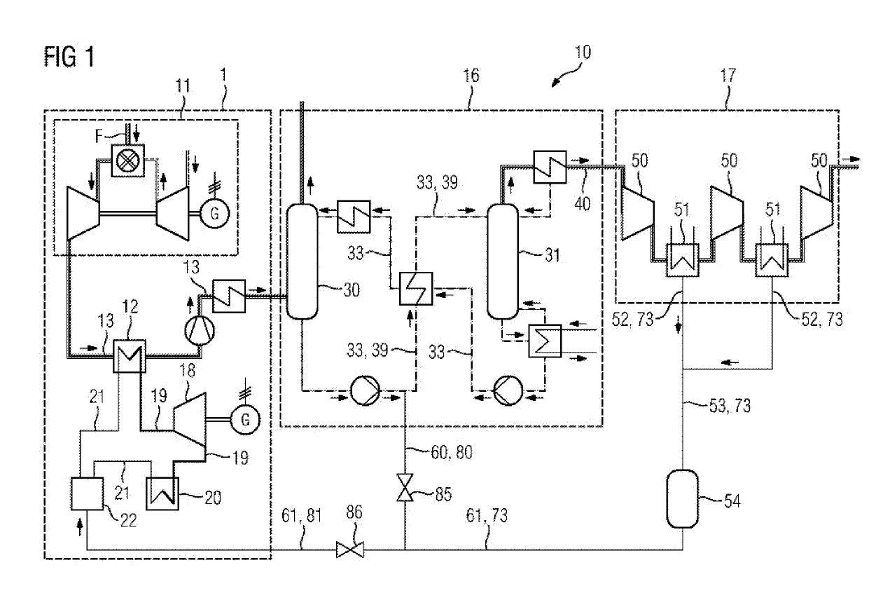

FIG. 1 shows a fossil-fired power plant 10, with a gas turbine plant as combustion apparatus 11, a heat recovery steam generator 12 which, via a flue gas duct 13, is connected downstream to the gas turbine of the combustion apparatus 11, a condenser 20, a demin-water treatment plant 22, CO₂ separation apparatus 16 which is connected into the flue gas duct 13, and a compressor 17, having a number of compressor stages and intercooling stages 50, 51, which is connected downstream to the CO₂ separation apparatus 16.

In the gas turbine plant of the combustion apparatus 11, a fossil fuel is combusted, wherein flue gas containing CO₂ is formed. The flue gas is fed to the heat recovery steam generator 12 via a flue gas duct 13 for producing steam 19. The steam 19 is fed in turn to a steam turbine plant 18, which is not shown in more detail here, where it is expanded, is then fed to a condenser 20, and expanded to form feed water 21. After the condensing of the steam 19 in the condenser, the feed water 21 is fed to a demin-water treatment plant 22. The demin-water treatment plant 22 is connected in turn to the heat recovery steam generator 12, via a feed-water line 21, for feedback of the feed water. The line for the steam 19 and the line for the feed water 21 form a water-steam cycle.

The heat recovery steam generator 12 is connected to the CO₂ separation apparatus 16 for discharging the flue gas 13. The CO₂ separation apparatus 16 in essence comprises an absorber 30 and a desorber 31 which are connected into an absorption medium circuit 33. Provision is made in the absorption medium circuit 33 for various heat exchangers, valves and pumps, which are not additionally elaborated upon. The CO₂ separation apparatus 16 releases gaseous CO₂ 40, largely freed of other constituents, which is fed to the compressor 17.

The compressor 17 comprises a number of compressor stages 50 and intercoolers, or cooler stages 51, which are arranged between the compressor stages. The intercoolers 51 have a condensate outlet 52 which converge in a condensate drain line 53. The condensate drain line 53 is connected to a condensate storage reservoir 54.

The storage reservoir 54 is connected in turn via a condensate line 60 to the absorption medium circuit 33, preferably to the line for the loaded absorption medium 39. A control valve 85, via which the volume of condensate which is supplied can be adjusted, is connected into the condensate line 60 in this case. Also connected to the storage reservoir 54 is a condensate line 61 which connects the storage reservoir 54 to the demin-water treatment plant 22. A control valve 86 for controlling the condensate flow is also connected into the condensate line 61. Pumps or discharge valves, which can also be connected into the condensate lines 60, 61, are not shown.

Also not shown is a further condensate line which connects the storage reservoir 54 to the water-steam cycle of the steam turbine plant 18.

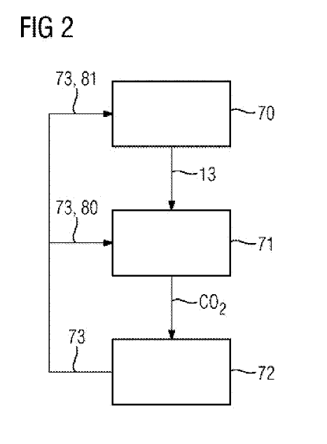

FIG. 2 shows a method for relieving the load of a water treatment plant of a fossil-fired power plant with CO₂ separation apparatus, comprising a power plant process 70, a CO₂ separation process 71 which is connected downstream to the power plant process 70, and a compressor process 72 which is connected downstream to the CO₂ separation process. In the power plant process 70, flue gas 13 is produced and fed to the CO₂ separation process 71 for separation. In the CO₂ separation process, CO₂ is separated from the flue gas 13. The separated, gaseous CO₂ is subsequently fed to the compressor process 72 where it is compressed in a plurality of process stages, this not being shown in more detail here, however. Cooling of the CO₂ is carried out between the compressor stages, wherein a condensate 73 is formed. The condensate is now fed back as makeup water 80 to the CO₂ separation process 71 and alternatively to this, or at the same time, fed back again into the power plant process 70 as feed water 81. The makeup water 80 in this case is preferably introduced into the flow with loaded absorption medium. The feed water 81 is preferably introduced into the condenser or into a water treatment plant which includes the power plant.

1-10. (canceled)

11. A fossil-fired power plant comprising:
a fossil-fired combustion apparatus with separation of flue gas,
a CO₂ separation apparatus, connected downstream to the fossil-fired power plant, for separating CO₂ from the flue gas, comprising an absorber and a desorber which are connected into an absorption medium circuit, and
a CO₂ compressor station, connected downstream to the CO₂ separation apparatus and connected to the desorber for discharging separated CO₂, and which for liquefying the separated CO₂ comprises a compressor with a number of compressor stages,
wherein a cooler, or a plurality of coolers, is or are connected between the compressor stages for the intercooling of the compressed CO₂, and
wherein the cooler is connected via a condensate line to the absorption medium circuit of the CO₂ separation apparatus so that water which condenses during the intercooling of the CO₂ can be provided as makeup water flow for the CO₂ separation apparatus.

12. A fossil-fired power plant comprising:
a fossil-fired combustion apparatus with separation of flue gas,
a CO₂ separation apparatus, connected downstream to the fossil-fired power plant, for separating CO₂ from the flue gas, comprising an absorber and a desorber which are connected into an absorption medium circuit, and
a CO₂ compressor station, connected downstream to the CO₂ separation apparatus and connected to the desorber for discharging separated CO₂, and which for liquefying the separated CO₂ comprises a compressor with a number of compressor stages,
wherein a cooler, or a plurality of coolers, is or are connected between the compressor stages for the intercooling of the compressed CO₂, and
wherein the cooler is connected via a condensate line to a treatment plant of the fossil-fired power plant for providing demineralized water so that water which condenses during the intercooling of the CO₂ can be made available to the treatment plant as prepurified water.

13. A method for the recovery of condensate, which is a constituent of a fossil-fired power plant process, to which a CO₂ separation process is connected downstream, wherein a compressor process is connected downstream to the CO₂ separation process and comprises a number of process stages between which a cooling process is connected in each case, comprising:
extracting condensate from the cooling processes, and
feeding the extracted condensate as prepurified water to a treatment process for demineralized water which comprises the power plant process.

14. A method for the recovery of condensate, which is a constituent of a fossil-fired power plant process, to which a CO₂ separation process is connected downstream, wherein a compressor process is connected downstream to the CO₂ separation process and comprises a number of process stages between which a cooling process is connected in each case, comprising:
extracting condensate from the cooling processes, and
feeding the extracted condensate as makeup water to the CO₂ separation process of a water circuit which includes an absorption and desorption process.
